(19) United States
(12) Patent Application Publication
(10) Pub. No.: US 2025/0030025 A1
(43) Pub. Date: Jan. 23, 2025

(54) FUEL CELL SYSTEM

(71) Applicant: AVL List GmbH, Graz (AT)

(72) Inventor: Raphael NEUBAUER, Graz (AT)

(73) Assignee: AVL List GmbH, Graz (AT)

(21) Appl. No.: 18/710,206

(22) PCT Filed: Nov. 14, 2022
(86) PCT No.: PCT/AT2022/060394

§ 371 Date: May 15, 2024

(30) Foreign Application Priority Data
Nov. 15, 2021 (AT) A 50912/2021

(51) Int. Cl. H01M 8/0612; C01B 3/38; H01M 8/0662

(52) U.S. Cl. CPC H01M 8/0631; C01B 3/382; H01M 8/0662; C01B 2203/0233; C01B 2203/0261; C01B 2203/067; C01B 2203/0838; C01B 2203/142; H01M 2250/10; H01M 2250/20

(57) ABSTRACT

Fuel cell system (1), in particular an SOFC system, comprising at least one fuel cell stack (2) with an anode section (3) and a cathode section (4), an air supply section (5), a fuel supply section (6) with a reformer, in particular a reformer heat exchanger (7) and an exhaust section (8) with an oxidation catalyst (9), characterised in that a CPOX reformer (10) is provided for the production of shielding gas by catalytic partial oxidation.

The invention further relates to the use of such a fuel cell system (1).

The invention relates to a fuel cell system, in particular an SOFC system, comprising at least one fuel cell stack with an anode section and a cathode section, an air supply section, a fuel supply section with a reformer, in particular a reformer heat exchanger, and an exhaust section with an oxidation catalyst.

The invention further relates to the use of such a fuel cell system.

SOFC systems are known from the prior art. Many fuel cell systems, in particular high-temperature fuel cell systems, require a shielding gas to protect the fuel cell stack, in particular the fuel electrode, from degradation during the heating-up process. It may be necessary to introduce heat into the system. However, this is not readily possible, since there are very different temperature requirements in the fuel cell system.

This is the starting point for the invention. The object of the invention is to provide a fuel cell system which can be heated up particularly efficiently, while at the same time in particular protecting the fuel cell stack from degradation.

A further object is to specify the use of such a fuel cell system.

According to the invention, this object is achieved in that, in a fuel cell system of the type mentioned above, a CPOX reformer is provided for the production of shielding gas by means of catalytic partial oxidation.

In particular, one advantage achieved by this is that, due to the arrangement of the CPOX reformer in the fuel cell system, the fuel cell stack is efficiently protected during the heating-up process. Within the scope of the invention, a reformer for the production of shielding gas by catalytic partial oxidation (CPOX reformer) has proved to be an effective means of producing a suitable shielding gas internally. In particular, air and fuel are catalytically converted into a synthesis gas in the CPOX reformer. This reaction is exothermic and therefore self-sustaining.

The CPOX reformer is part of the fuel cell system, which is in particular designed as a high-temperature fuel cell system and preferably as a SOFC system.

In the fuel cell system according to the invention, an air supply section is provided via which air can be conveyed in the direction of the cathode. In the context of the invention, air is to be understood as a gas containing oxygen. The fuel cell system also has a fuel supply section via which fuel can be conveyed from a fuel source in the direction of the anode section. A carbonaceous gas such as methane or ethane, natural gas or hydrogen can for example be used as fuel. In principle, a liquid fuel can also be used.

The reformer reforms fuel for conversion in the anode section and the oxidation catalyst converts remaining fuel fractions into the exhaust gas before it is released into the environment. Of course, other components are preferably provided in the fuel cell system, for example heat exchangers and a recirculation section with a fan for recirculating anode exhaust gas in the direction of the anode section. The reformer is in particular designed as a reformer heat exchanger and is preferably arranged and designed to carry out steam reforming.

It is advantageous if a heat source is provided for the CPOX reformer. As a result, the CPOX reformer can be brought above the so-called light-off temperature before the catalyst is oxidised. The light-off temperature is a defined threshold temperature above which the CPOX reformer functions properly, i.e. at what point the self-sustaining catalytic partial oxidation starts.

It is advantageous if the heat source is designed as a starting burner. For this purpose, the starting burner is also preferably integrated into the fuel cell system and normally has the main function of bringing the fuel cell system up to operating temperature. A component of the fuel cell system which is in any case necessary is thus used to heat up the CPOX reformer, which means that heat from the fuel cell system itself is used to heat up the CPOX reformer. In principle, it can also be advantageous if another component of the fuel cell system is used as a heat source for the CPOX reformer.

Alternatively, it can also be advantageous if external, electric or thermal heat can be used as a heat source.

In any case, as soon as the CPOX reaction has started, the additional energy is no longer needed in any of these cases.

It is advantageous if an air line from an air source and a fuel line from a fuel source to the CPOX reformer are provided. The fuel cell system advantageously includes an air source from which air is conveyed via the air supply section in the direction of the cathode. The fuel cell system also preferably includes a fuel source from which fuel is pumped via the fuel supply section in the direction of the anode. In order to supply the CPOX reformer with air and fuel for catalytic oxidation, the air source and the fuel source are fluidically connected to the air line and the fuel line respectively. This avoids the need to provide air and fuel for the CPOX reformer separately. Preferably, the air source and the fuel source are also fluidically connected to the starting burner.

It is advantageous if a fluidic connection is provided between the CPOX reformer and the fuel supply section, whereby the shielding gas produced by the CPOX reformer can be introduced into the fuel supply section in particular upstream or downstream of the reformer or reformer heat exchanger. Introducing this upstream or downstream of the reformer or reformer heat exchanger has the following advantages: the shielding gas from the CPOX reformer typically has a temperature of more than 600° C. In order to be able to comply with any temperature limitation, it is cooled in the reformer or reformer heat exchanger upstream of the fuel cell stack in order to protect the fuel cell stack from excessively high inlet temperatures. In addition, the shielding gas can also be used for the activation of for example Ni-based catalysts in the reformer. If neither temperature nor reformer activation are a problem, the shielding gas can also advantageously be introduced directly before the fuel cell stack, i.e. downstream of the reformer or the reformer heat exchanger.

Alternatively, it can be advantageous if the CPOX reformer is integrated into the reformer, in particular into the reformer heat exchanger. This makes it possible to keep the complexity and installation space of the entire fuel cell system low. This is advantageous because no additional fuel line and no additional reformer are required. In this case, the heating to above the light-off temperature of the CPOX reformer advantageously takes place internally within the fuel cell system, namely by means of the hot cathode exhaust gas itself, whereby the light-off temperature lies in a range between 250° C. and 500° C. here. In order to enable a CPOX reformer designed in this way to be heated by a cathode exhaust gas, the reformer is advantageously designed as a reformer heat exchanger, whereby a hot side of the reformer heat exchanger is arranged in a cathode discharge line. This means that the reformer heat exchanger and the CPOX reformer integrated therein are brought to operating temperature by the hot cathode exhaust gas. The reformer heat exchanger comprises a cold side upstream of the anode section, which forms a reformer and the CPOX reformer, and a hot side downstream of the cathode section, which forms a heat exchanger. It has transpired that, taking into account various factors, it is quite possible, and can also be advantageous, to feed the cathode exhaust gas completely to the heat exchanger on the reformer or the hot side of the reformer heat exchanger. In the first place, it is advantageous that there is no need for flow dividers downstream of the cathode section. Flow dividers lead to a complex system structure, for which correspondingly complex functional components are required. These are not only expensive, but are also reflected in the weight, which should always be reduced, in particular in mobile applications. In addition, the use of flow dividers means that complex control and regulation steps need to be implemented in the fuel cell system. These can be dispensed with if the cathode exhaust gas is directed from the cathode section directly and unbranched, i.e. completely, to the heat exchanger on the reformer heat exchanger.

As soon as the CPOX reaction has started, the exothermic CPOX reaction begins (on reaching 600° C. or more), as a result of which the reformer's catalyst is actively cooled (in metal-based fuel cell stacks for example, the cathode exhaust gas temperature is usually below 600° C. during the heating process). The reformer catalyst is preferably designed for both CPOX reforming and steam reforming. This can preferably be achieved using a two-stage reformer (precious metal catalyst followed by a Ni-based catalyst) or using a correspondingly robust single-stage catalyst. With this integration, it is advantageous if the reformer as a whole catalyses both reactions (i.e. CPOX and steam reforming). However, this results in high requirements as regards the catalyst and thus also high costs.

However, alternatively, it is also advantageous if the reformer, in particular the reformer heat exchanger, has two areas, the first area having a catalyst of the CPOX reformer and a second area having a catalyst for steam reforming. In this case, the catalysts are thus structured successively. For this purpose, the CPOX reaction advantageously takes place in the first area and steam reforming in the second area, whereby the second area is arranged downstream of the first area. As a result, a reaction gas first flows through the first area and then through the second area. The reason for this sequence is that the CPOX reaction contains oxygen, for which reason the catalyst is adapted to an oxidising environment, and the steam reforming does not (a stabilisation of the catalyst with respect to oxygen is not necessary here). As a result of this arrangement, the first area can already convert oxygen so that oxygen is no longer present in the second area, because this has already been converted in the first area.

The area for the CPOX reaction (first area) is advantageously smaller than the second area, for example the first area can advantageously make up around ¼ of the total area and the second area around ¾ of the total area. However, this division can also expediently be ⅓ and ⅔ or ⅖ and ⅗ or ⅕ and ⅘. This is because, as a rule, significantly less gas is converted in the CPOX reaction, since substantially only the fuel cell stack needs to be protected. Possible catalysts for the catalyst of the CPOX reformer are precious metals. For the catalyst of the steam reformer, these are precious metals and/or nickel, for example. Nickel is usually cheaper than precious metals, but it is sensitive to oxygen.

The reformer with integrated CPOX reactor for shielding gas generation can be designed as a plate heat exchanger, as a shell-and-tube heat exchanger with catalyst fill or as a monolith.

A fuel cell system according to the invention can be used advantageously as a stationary system or in a motor vehicle. The fuel cell system according to the invention can also be used advantageously in marine applications or aircraft.

Further advantages, features and details of the invention are explained in the following description, in which exemplary embodiments of the invention are described in detail with reference to the drawing. In each case schematically:

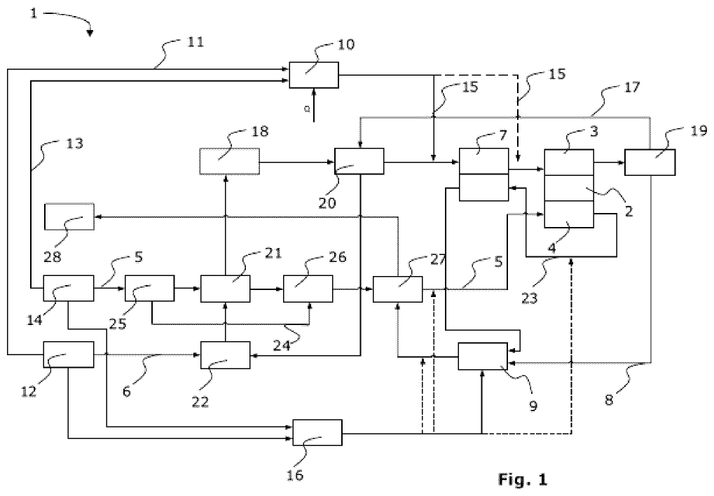

FIG. 1 shows a schematic representation of a fuel cell system according to the invention;

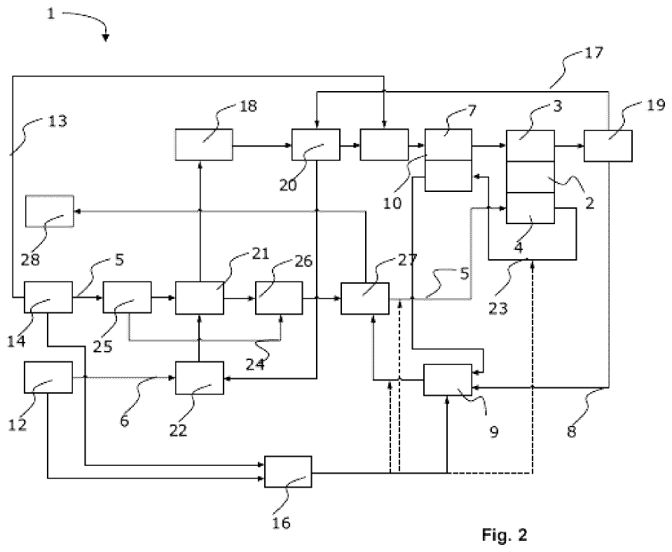

FIG. 2 shows a schematic representation of another fuel cell system according to the invention.

FIG. 1 shows a fuel cell system 1 according to the invention with a fuel cell stack 2 comprising an anode section 3 and a cathode section 4. An air source 14 is provided, to which an air supply section 5 is connected to convey air in the direction of the cathode section 4. A fuel source 12 is also provided, to which a fuel supply section 6 is connected to convey fuel in the direction of the anode section 3. The fuel cell system 1 also includes a recirculation section 17, via which exhaust gas from the anode section 3 is conveyed back in the direction of the anode section 3 by a fan 18. Downstream of the fuel cell stack 2, a first dividing device 19 is provided by means of which the anode exhaust gas can be divided into the recirculation section 17 and into the exhaust section 8.

The part of the anode exhaust gas in the recirculation section 17, i.e. the recirculated exhaust gas, is passed through a first heat exchanger 20 and a second heat exchanger 21. The first heat exchanger 20 is arranged upstream of the second heat exchanger 21, whereby a hot side of the first heat exchanger 20 is arranged in the recirculation section 17 and a cold side of the first heat exchanger 20 is arranged in the fuel supply section 6. Heat is thus extracted from the hot anode exhaust gas and the first heat exchanger 20 is designed as a fuel/fuel heat exchanger. The fan 18, which is designed as a recirculation fan, is arranged between the first heat exchanger 20 and the second heat exchanger 21 and is designed to convey the anode exhaust gas.

Upstream of the second heat exchanger 21, a fluidic connection 22 is provided between the recirculation section 17 and the fuel supply section 6, so that fresh fuel can be introduced into the recirculation section 17 via the fuel supply section 6. The fresh fuel, together with the recirculated exhaust gas, is now conveyed in the fuel supply section 6 in the direction of the anode section 3. In a first step, this fuel is passed through the cold side of the first heat exchanger 20, as a result of which this is heated up again.

A reformer heat exchanger 7 is arranged upstream of the anode section 3 and downstream of the cold side of the first heat exchanger 20 which prepares the fuel for use in the anode section 3. Cathode exhaust gas is supplied to the reformer heat exchanger 7 via the cathode discharge line 23 to heat up the corresponding reformer section.

The air supply section 5 has a bypass line 24 via which the second heat exchanger 21 can be bypassed. For this purpose, a branch 25 is provided upstream of the cold side of the second heat exchanger 21 from which the bypass line 24 branches off, and a connection 26, where the bypass line 24 reconnects, is provided downstream of the cold side of the second heat exchanger 21. A further heat exchanger 27 is provided downstream of the connection 26, with its cold side arranged in the air supply line 5 and its hot side arranged in the exhaust section 8, so that the hot exhaust gas transfers heat to the air for use in the cathode section 4.

The cold side of the first heat exchanger 20 is arranged in the fuel supply section 6 and the hot side of the first heat exchanger 20 is arranged in the recirculation section 17. The cold side of the second heat exchanger 21 is arranged in the air supply section 5 and the hot side of the second heat exchanger 21 is preferably arranged in the fuel supply section 6, whereby the hot side of the second heat exchanger 21 can also be arranged in the recirculation section 17.

An oxidation catalyst 9 is arranged in the exhaust section 8, whereby both the exhaust line and the cathode discharge line 23 (downstream of the reformer heat exchanger 7) lead into this. In other words, anode exhaust gas is combusted with cathode exhaust gas being supplied. The combusted exhaust gas is then discharged to the environment 28 via the further heat exchanger 27.

The fuel cell system 1 according to FIG. 1 also includes a starting burner 16, which is supplied with both fuel from the fuel source 12 as well as air from the air source 14. The starting burner 16 is arranged and designed to heat up the fuel cell system 1. For this purpose, the heat is for example supplied directly to the oxidation catalyst 9 (solid line) or the exhaust section downstream thereof, or to the air supply line 5 or the cathode exhaust line 23 (in each case represented by dashed lines).

In addition, a CPOX reformer 10 is provided for the production of shielding gas by catalytic partial oxidation. As shown in FIG. 1, both fuel and air are also supplied to this via a fuel line 11 or an air line 13 from the fuel source 12 or the air source 14. Since a certain light-off temperature is required to bring the CPOX reformer 10 up to operating temperature, a heat source Q is provided for the CPOX reformer 10. The CPOX reformer 10 or the reaction that takes place therein produces a so-called shielding gas which can for example be fed in upstream (solid line) or downstream (dashed line) of the reformer heat exchanger 7 in order to protect the fuel cell stack 2 in particular.

FIG. 2 shows another fuel cell system 1 according to the invention. Elements which have the same function and in particular the same arrangement as those shown in FIG. 1 also have the same reference signs and are not described further. In contrast to FIG. 1, in the fuel cell system 1 according to FIG. 2 the CPOX reformer 10 for the production of shielding gas by catalytic partial oxidation is not designed and arranged as a separate element, but is integrated into the reformer part of the reformer heat exchanger 7. For this purpose, the reformer heat exchanger 7 is designed for both CPOX and also steam reforming.

It goes without saying that this is only an exemplary representation of a fuel cell system 1, which does not necessarily have to have all the elements described in FIGS. 1 and 2. For example, the fuel cell system 1 can also be designed without a recirculation section 17.

In summary, the fuel cell system according to the invention has the following advantages in particular:
A shielding gas for the fuel cell stack and the reformer catalyst activation is generated internally within the system;
The reactor for shielding gas generation can be integrated into the reformer, thus simplifying the system;
The initial heating of the CPOX reformer 10 can be accomplished internally within the system, as a result of which the catalyst can be actively cooled, also during operation, in order to reduce the risk of thermal degradation.

1. A fuel cell system, comprising at least one fuel cell stack with an anode section and a cathode section, an air supply section, a fuel supply section with a reformer and an exhaust section with an oxidation catalyst, wherein a Catalytic Partial Oxidation (CPOX) reformer is provided for the production of shielding gas by catalytic partial oxidation.

2. The fuel cell system according to claim 1, wherein a heat source (Q) is provided for the CPOX reformer.

3. The fuel cell system according to claim 2, wherein the heat source (Q) is designed as a starting burner.

4. The fuel cell system according to claim 1, characterised in that a fuel line from a fuel source and an air line from an air source to the CPOX reformer is provided.

5. The fuel cell system according to one claim 1, wherein a fluidic connection is provided between the CPOX reformer and the fuel supply section.

6. The fuel cell system according to claim 1, wherein the CPOX reformer is integrated into the reformer.

7. The fuel cell system according to claim 6, wherein the reformer has two areas, the first area having a catalyst of the CPOX reformer and a second area having a catalyst for steam reforming.

8. A method of using the fuel cell system according to claim 1 as a stationary installation or in a motor vehicle.

9. The fuel cell system according to claim 1, wherein the fuel cell system is a (solid oxide fuel cell) SOFC system.

10. The fuel cell system according to claim 1, wherein the reformer is a reformer heat exchanger.

11. The fuel cell system according to claim 1, wherein the shielding gas produced by the CPOX reformer is introduced into the fuel supply section upstream or downstream of the reformer.
